(19) United States
(12) Patent Application Publication
(10) Pub. No.: US 2014/0178628 A1
(43) Pub. Date: Jun. 26, 2014

(54) PET DOOR FLAP ATTACHMENT

(71) Applicant: Fido Flaps, LLC, Highland Village, TX (US)

(72) Inventor: Tricia Hoffmann, Highland Village, TX (US)

(73) Assignee: Fido Flaps, LLC, Highland Village, TX (US)

(21) Appl. No.: 14/080,242

(22) Filed: Nov. 14, 2013

Related U.S. Application Data
(60) Provisional application No. 61/726,228, filed on Nov. 14, 2012.

(51) Int. Cl. E06B 7/28; A01K 29/00

(52) U.S. Cl. CPC E06B 7/28; A01K 29/00
USPC 428/100

(57) ABSTRACT

A pet door flap attachment may be easily installed and removed by a user to allow for cleaning of the attachment. A pet door flap attachment may include at least one covering and a coupling mechanism to removeably couple the at least one covering to a pet door flap.

### CROSS REFERENCE TO RELATED APPLICATIONS

This application claims the benefit under 35 U.S.C. §119(e) of U.S. Provisional Patent Application Ser. No. 61/726,228 filed on Nov. 14, 2012 and entitled “Fido Flaps Are A Custom, Decorative, Removable And Machine Washable Fabric Flap Cover For Dog And Pet Doors,” which is incorporated herein by reference in its entirety.

### TECHNICAL FIELD

The present disclosure relates generally to pet door flaps, and in particular, to attachments for covering existing pet door flaps.

### BACKGROUND

Pet doors allow a pet to enter and exit a dwelling or other indoor location on its own without the assistance of a person to manually open the door. Pet doors generally include plastic or vinyl flaps through which the pet enters and exits. These pet door flaps accumulate dirt, grime, fecal matter and other bacteria. Conventional pet door flaps are not easily removable for cleaning. Instead, cleaning generally entails scrubbing in place while the pet door flap is still installed on the pet door.

### SUMMARY

Embodiments of the present disclosure generally provide decorative, durable and washable attachments for use in conjunction with existing pet door flaps that allow for quick and convenient installation and removal.

Embodiments of the present disclosure generally provide an attachment system for use in conjunction with pet doors. The system includes a first covering and a first coupling mechanism to removeably couple the first covering to a first side of a pet door flap. The first covering may be made of a machine washable fabric and the first coupling mechanism may be a hook-and-loop fastener. The first covering may have a decorative element. The system may further comprise a second covering. The second covering may be made of a machine washable fabric. The system may further comprise a second coupling mechanism to removeably couple the second covering to a second side of the pet door flap. The second coupling mechanism may be a hook-and-loop fastener. The second covering may have a decorative element.

Embodiments of the present disclosure may further provide an attachment system including a covering and a coupling mechanism to removeably couple the covering to a surface selected from the group consisting of: a pet door flap, a door, a wall and a window. The covering may be made of a machine washable fabric. The coupling mechanism may be a hook-and-loop fastener. The covering may include a first side and a second side, and the first side may be disposed against the surface. The covering may include a decorative element disposed along the second side. The system may further comprise a second covering and a second coupling mechanism to removeably couple the second covering to an opposing surface to the surface.

Other embodiments of the present disclosure may provide an attachment system for use in conjunction with pet doors, the system including a covering, and a coupling mechanism to removeably couple the covering to a first side of a pet door flap. The covering may include a first side and a second side, and the first side may be disposed against the first side of the pet door flap. The covering may be made of a machine washable fabric selected from the group including polyester, acrylic, synthetic fiber, olefin, polyester-cotton blends, cotton blends, vinyl blends and outdoor fabric. The coupling mechanism may include a hook-and-loop fastener. The covering may include a decorative element disposed along the second side. The system may further include another covering removeably coupled to a second side of the pet door flap.

In an embodiment, the present disclosure provides pet door flap attachments that may be easily and conveniently installed and removed by a user to allow for cleaning via machine washing or hand washing, saving time and limiting exposure to contaminants that may be left behind during spot cleaning alone.

In an embodiment, the present disclosure further provides a decorative medium that may be customizable and changed as desired. In an embodiment, pet door flap attachments may be easily replaced such that the appearance of a pet door, door, wall, window or other suitable surface may be quickly and efficiently changed as desired.

In an embodiment, the present disclosure provides a durable pet door flap attachment that may withstand washing, wear, the elements, abuse by pets, and similar wearing events. The pet door flap attachment may be easily replaced as needed, reducing replacement costs of pet doors and pet door flaps.

Other technical features may be readily apparent to one skilled in the art from the following figures, descriptions and claims.

### BRIEF DESCRIPTION OF THE DRAWINGS

For a more complete understanding of the present disclosure and its features, reference is now made to the following description, taken in conjunction with the accompanying drawings, in which:

FIG. 1 is a perspective view of a pet door flap attachment coupled to an interior surface of a pet door flap in accordance with one embodiment of the present disclosure;

FIG. 2 is a plan view of a pet door flap attachment coupled to an exterior surface of a pet door flap in accordance with one embodiment of the present disclosure; and

FIG. 3 is an exploded view of the pet door flap attachments of FIGS. 1 and 2 in accordance with one embodiment of the present disclosure.

### DETAILED DESCRIPTION

The present disclosure generally provides decorative, durable and washable attachments for covering pet door flaps. The pet door flap attachments allow for quick and convenient installation and removal for ease of cleaning and replacement.

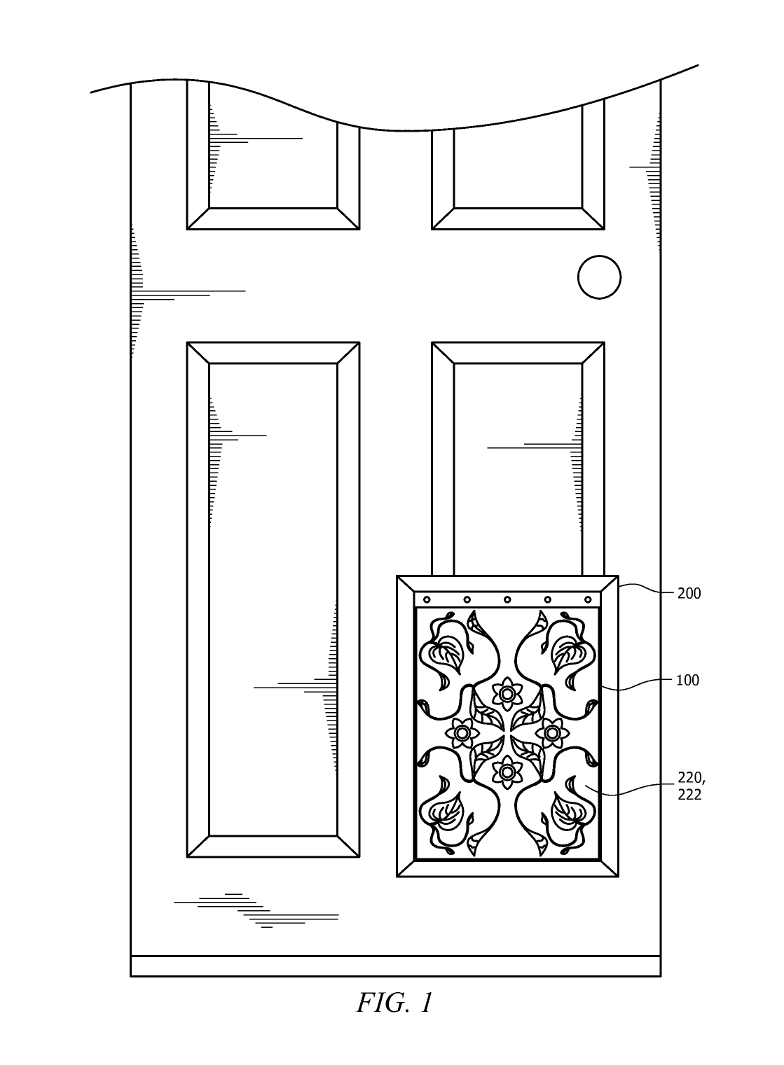

FIGS. 1-3 generally illustrate a pet door flap attachment 100 according to an embodiment of the present disclosure. Attachment 100 may be used in conjunction with a variety of pet doors 200. It should be understood that attachment 100 shown in FIGS. 1-3 is for illustrative purposes only and that any other suitable system or subsystem could be used in conjunction with or in lieu of attachment 100 according to one embodiment of the present disclosure.

It should be appreciated that attachment 100 may be employed in conjunction with other objects besides pet doors. In some embodiments, attachment 100 may be used in conjunction with any type of door, wall, window or other suitable surface to provide protection from scratches, marks, or other forms of damage caused by pets. Attachment 100 may be secured or otherwise coupled to any suitable surface including, for example, a surface that includes glass, wood, metal, plastic, any suitable material, or any combination thereof. In addition, attachment 100 may be secured or otherwise coupled to a smooth, grooved, beveled, painted, coated, sealed, or treated surface according to one embodiment of the present disclosure.

Pet doors 200 may be employed in conjunction with a swing door, a panel door, a track operated door, a trackless door, an overhead door, a sectional door, a rolling door, a roll-up door, a retractable door, a collapsible door, a canopy-like door, a ball-bearing door, a sliding door, a magnetic door, a push-pull door, a rack and pin controlled door, a remote controlled door, a wall, a drywall, a movable wall, a movable window, a movable panel, a piece of furniture, a curtain, a divider, a controllable opening, a configurable aperture, other door-like apparatus, or any suitable combination thereof.

Pet doors 200 may generally include a pet door flap 220, which allows pets to enter and exit an indoor setting unassisted. Pet door flap 220 may generally comprise an interior surface 222 exposed to the inside of a dwelling or other indoor setting and an exterior surface 224 exposed to the outside of the dwelling or other indoor setting.

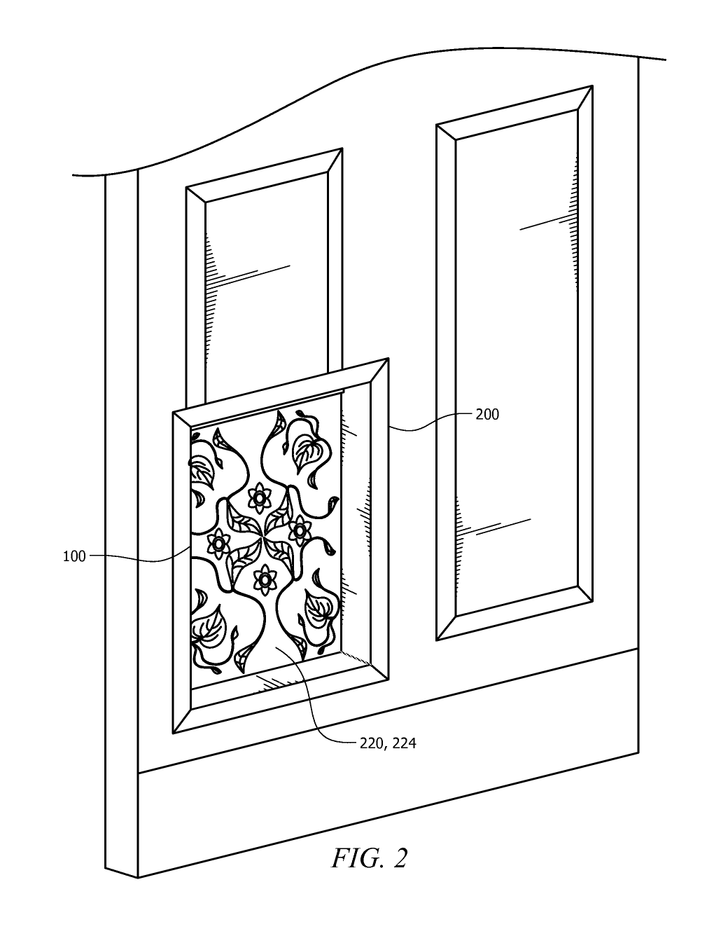

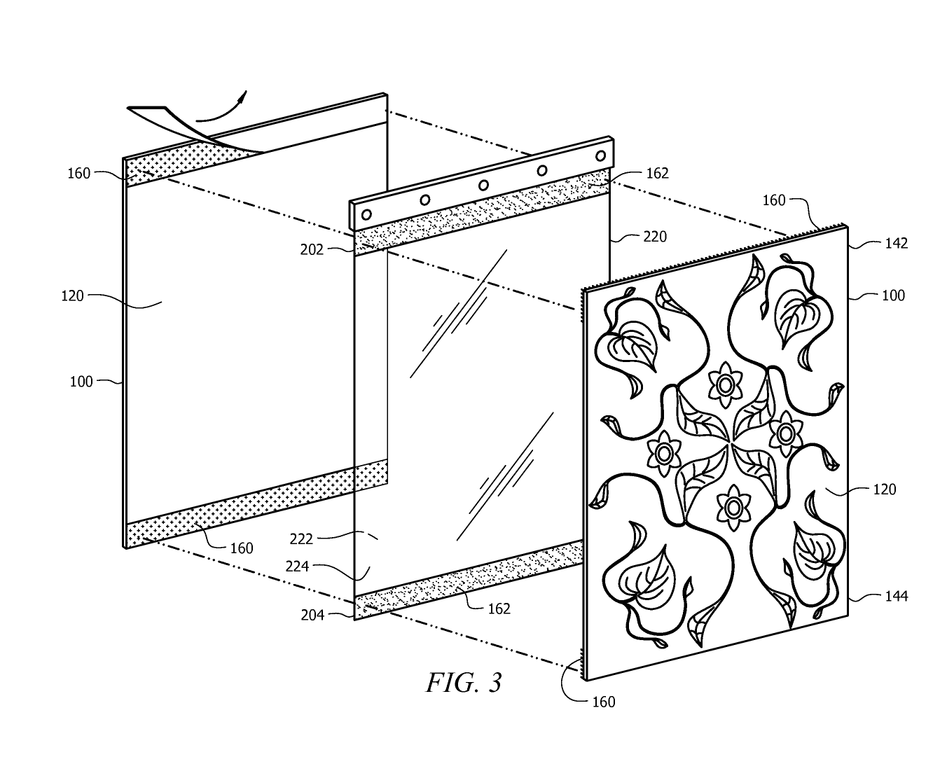

FIG. 1 depicts attachment 100 coupled to interior surface 222 of pet door flap 220. FIG. 2 depicts attachment 100 coupled to exterior surface 224 of pet door flap 220. FIG. 3 depicts an exploded view of attachments 100 coupled to interior surface 222 and exterior surface 224 of pet door flap 220.

Attachment 100 may generally comprise exposed surface 120 and attachment surface 140 according to one embodiment of the present disclosure. Attachment surface 140 may include top section 142 and lower section 144.

Attachment 100 may be secured or otherwise coupled with any portion of pet door flap 220 in any suitable manner including, for example, using hook-and-loop fasteners such as loops 160 and hooks 162 as shown in FIG. 3, magnets, snaps, temporary adhesive, removable adhesive tab, peel-and-stick materials, male and female coupling adapters, spray adhesive, clay, putty, sticky material, staples, retaining structures, clips, screws, pins, other suitable adhesive or retaining devices, or any combination thereof.

In one embodiment, top loops 160 may be coupled to top section 142 and lower loops 160 may be coupled to lower section 144, respectively, of attachment surface 140. Likewise, top hooks 162 and lower hooks 162 may be coupled to pet door flap 220 at top position 202 and lower position 204 corresponding to top section 142 and lower section 144 of attachment surface 140, respectively. Thus, when attachment surface 140 of attachment 100 engages the pet door flap 220, the top loops 160 and lower loops 160 couple with the top hooks 162 and the lower hooks 162, respectively, to adhere attachment 100 to pet door flap 220.

Attachment 100 may be cut, configured, or otherwise sized to custom fit pet door flap 220 or portions of a door, wall, window or other suitable surface not having a pet door according to one embodiment of the present disclosure. For example, attachment 100 may be customized to any suitable shape, size, thickness, or configuration in accordance with the present disclosure.

In one embodiment, attachment 100 may have a width (w) and a length (l) generally measuring about the same sizes as the width (W) and the length (L) of pet door flap 220. In other embodiments, the width (w) and length (l) of attachment 100 may be varied to accommodate different sizes and shapes of pet doors and pet door flaps. Although attachment 100 is generally illustrated as a rectangular shaped structure in FIGS. 1-3, it should be understood that any suitable shape, size, thickness, material, or configuration for attachment 100 could be used in accordance with the present disclosure.

In one embodiment, attachment 100 may be machine or hand sewn and made of a washable material, such as polyester, acrylic, machine washable fabric, synthetic fiber, olefin, polyester-cotton blends, cotton blends, vinyl blends, outdoor fabric, other suitable material, or any combination thereof. In one embodiment, attachment 100 may be made of fabrics having certain qualities including colorfastness, durability, stain resistance and sturdiness.

In some embodiments, attachment 100 may be made of any suitable material, or contain materials to prevent the accumulation of dirt, grime, fecal matter, bacteria, environmental effects and other contaminants.

In one embodiment, attachment 100 may include any suitable pattern or print. It should be appreciated that attachment 100, according to one embodiment of the present disclosure, may provide a decorative medium. Attachment 100 may be easily replaced such that the appearance of a pet door, door, wall, window or other suitable surface may be quickly and efficiently changed as desired.

Attachment 100 could include any number of suitable coatings, layers, or additives to an entire surface, layer, sub-layer, or structure of attachment 100 or to a portion of a surface, layer, sub-layer, or structure of attachment 100 according to one embodiment of the present disclosure.

In one embodiment, attachment 100 may be embellished with different colors, stickers, removable stickers, paints, stencils, erasable markers, chalks, designs, patterns, images, wood grain patterns, novelty items, ornamental items, other decorative materials, or any combination thereof.

In some embodiments, over stitching and cosmetic stitches may be made to attachment 100 for a desired look.

In operation, a first attachment 100 and a second attachment 100 may each be sized and formed to fit the interior surface 222 and the exterior surface 224 of pet door flap 220. In one embodiment, top loops 160 may be secured or otherwise coupled to top section 142 of the attachment surface 140 of each attachment 100. Lower loops 160 may be secured or otherwise coupled to lower section 144 of the attachment surface 140 of each attachment 100.

In one embodiment, top hooks 162 may be secured or otherwise coupled to the top portion 202 of each surface 222, 224 of pet door flap 220. Lower hooks 162 may be secured or otherwise coupled to the lower portion 204 of each surface 222, 224 of pet door flap 220.

The first attachment 100 may then be secured or otherwise coupled to the interior surface 222 of pet door flap 220 so as to establish a firm connection via the hook-and-loop fastener, as shown in FIG. 3. The second attachment 100 may likewise be secured or otherwise coupled to the exterior surface 224 of pet door flap 220 so as to establish a firm connection via the hook-and-loop fastener, as shown in FIG. 3.

Once soiled, each attachment 100 may be removed and cleaned via machine washing or hand washing. The attachments 100 may then be replaced in a similar manner as when first installed.

Optionally, a user may replace one or both attachments 100 with another attachment(s) 100 having a different pattern, print or style, as desired.

It should be understood that the operational steps described herein are for illustrative purposes only and that any other suitable method or sub-method could be used in conjunction with or in lieu of the steps described herein according to one embodiment of the present disclosure. For example, in some embodiments, attachment(s) 100 may be removeably coupled to only one or the other of the interior surface 222 or the exterior surface 224 of the pet door flap 220, but not to both surfaces 222, 224. It should also be understood that the steps described herein could be performed in any suitable order or manner.

In one embodiment, the overall shape and configuration of attachment 100, as well as its method of application may provide a system that allows for the quick and convenient installation and removal of attachment 100 without the use of tools. The attachment mechanism, as well as the materials used in the construction of attachment 100 may provide protection from dirt, grime, fecal matter, bacteria, environmental effects or contaminants, which can be easily cleaned away by removing attachment 100 and processing the same through a washing machine or hand washing the same.

It should be understood that attachment 100 according to embodiments of the present disclosure is durable and may withstand washing, wear, the elements, abuse by pets, and similar wearing events. Thus, attachment 100 according to embodiments of the present disclosure may be repeatedly used and cleaned. Moreover, attachment 100 is secured to pet door flap 220 and may be easily replaced as needed, thereby reducing replacement costs of pet doors 200 and/or pet door flaps 220.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An attachment system for use in conjunction with pet doors, the system comprising:
a first covering; and
a first coupling mechanism to removably couple the first covering to a first side of the pet door flap.

2. The system of claim 1, wherein the first covering is made of a machine washable fabric.

3. The system of claim 1, wherein the first coupling mechanism comprises a hook-and-loop fastener.

4. The system of claim 1, wherein the first covering comprises a decorative element.

5. The system of claim 1, further comprising a second covering.

6. The system of claim 5, wherein the second covering is made of a machine washable fabric.

7. The system of claim 5, further comprising a second coupling mechanism to removably couple the second covering to a second side of the pet door flap.

8. The system of claim 7, wherein the second coupling mechanism comprises a hook-and-loop fastener.

9. The system of claim 1, wherein the second covering comprises a decorative element.

10. An attachment system comprising:
a covering; and
a coupling mechanism to removably couple the covering to a surface selected from the group consisting of: a pet door flap, a door, a wall and a window.

11. The system of claim 10, wherein the covering is made of a machine washable fabric.

12. The system of claim 10, wherein the coupling mechanism comprises a hook-and-loop fastener.

13. The system of claim 10, wherein the covering has a first side and a second side, wherein the first side is disposed against the surface.

14. The system of claim 13, wherein the covering comprises a decorative element disposed along the second side.

15. The system of claim 10, further comprising:
a second covering; and
a second coupling mechanism to removeably couple the second covering to an opposing surface to the surface.

16. An attachment system for use in conjunction with pet doors, the system comprising:
a covering; and
a coupling mechanism to removably couple the covering to a first side of a pet door flap,
wherein the covering has a first side and a second side, wherein the first side is disposed against the first side of the pet door flap.

17. The system of claim 16, wherein the covering is made of a machine washable fabric selected from the group consisting of:
polyester, acrylic, synthetic fiber, olefin, polyester-cotton blends, cotton blends, vinyl blends and outdoor fabric.

18. The system of claim 16, wherein the coupling mechanism comprises a hook-and-loop fastener.

19. The system of claim 16, wherein the covering comprises a decorative element disposed along the second side.

20. The system of claim 16, further comprising another covering removeably coupled to a second side of the pet door flap.
